(19) United States
(12) Patent Application Publication
(10) Pub. No.: US 2010/0104931 A1
(43) Pub. Date: Apr. 29, 2010

(54) BATTERY COVER LATCHING MECHANISM

(75) Inventors: Zhou-Quan Zuo, Shenzhen City (CN); Chu-Hua Jiang, Shenzhen City (CN); Hong Wu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/542,828

(22) Filed: Aug. 18, 2009

(30) Foreign Application Priority Data
Oct. 28, 2008 (CN) 200810305256.8

(51) Int. Cl. H01M 2/10

(52) U.S. Cl. 429/97

(57) ABSTRACT

A battery cover latching mechanism is provided. The battery cover latching mechanism includes a body member, a battery cover, and a button assembly. The battery cover includes a receiving space used to mount a battery with the battery cover. One end of the battery cover is rotatably mounted to the body member. The battery cover includes a latch. The button assembly includes a button member. The button member is slidably mounted to the body member. The button member includes a stopping block. The stopping block releasably latches with latch.

### BACKGROUND

1. Technical Field

The present disclosure relates to battery cover latching mechanisms and, particularly, to a battery cover latching mechanism used in a portable electronic device.

2. Description of Related Art

Batteries are used to provide power to portable electronic devices, e.g., mobile phones. Battery cover latching assemblies are usually provided to secure a battery within a portable electronic device.

A typical battery cover latching assembly for an electronic device usually includes a battery cover and latching means, e.g., a locking pin latching into a locking hole. The battery cover can be detachably mounted to a housing of portable electronic devices using the latching means.

However, removal of the battery cover may require a strong force, which may damage the locking pin.

Therefore, there is room for improvement within the art.

### BRIEF DESCRIPTION OF THE DRAWINGS

Many aspects of the battery cover latching mechanism can be better understood with reference to the following drawings. These drawings are not necessarily drawn to scale, the emphasis instead being placed upon clearly illustrating the principles of the present battery cover latching mechanism. Moreover, in the drawings like reference numerals designate corresponding sections throughout the several views.

FIG. 1 is an exploded, isometric view of a battery cover latching mechanism, in accordance with an exemplary embodiment.

FIG. 2 is similar to FIG. 1, but viewed from another aspect.

FIG. 3 is an enlarged, isometric view of the button member of FIG. 1.

FIG. 4 is an enlarged view of area IV of FIG. 1.

FIG. 5 is an assembled view of the battery cover latching mechanism of FIG

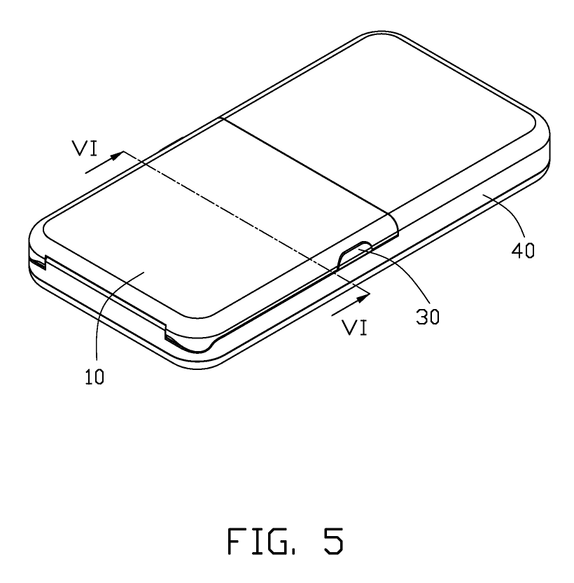

FIG. 6 is a cross-sectional view of the battery cover latching mechanism taken along line VI-VI of FIG. 5.

FIG. 7 is an isometric view of the battery cover with the battery shown in FIG

FIG. 8 is a schematic view, showing the working status of the battery cover latching mechanism.

### DETAILED DESCRIPTION

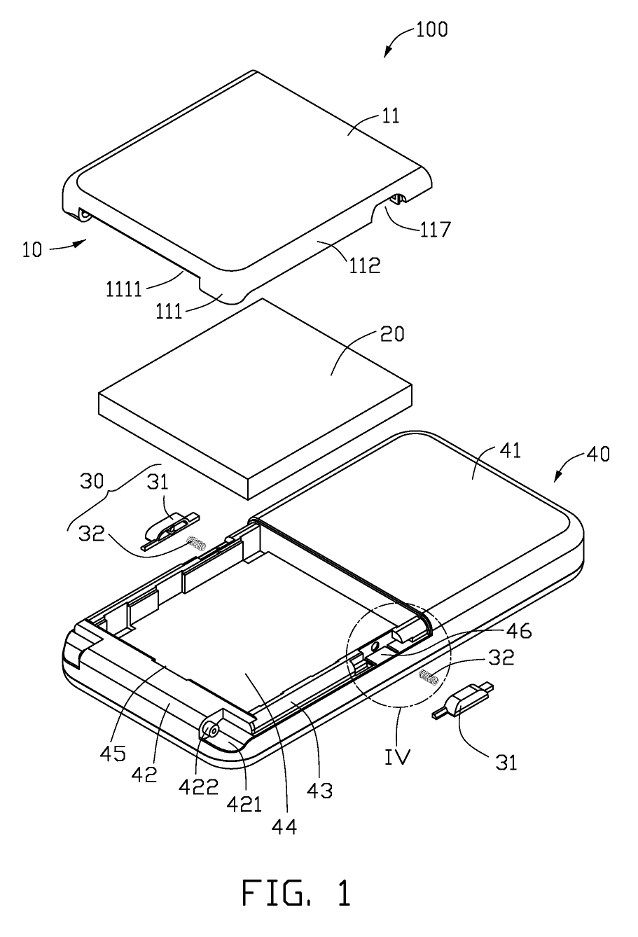

FIG. 1 shows an exemplary battery cover latching mechanism 100 including a battery cover 10, a battery 20, two button assemblies 30, and a body member 40. The battery cover 10 is rotatably mounted to the body member 40. The button assemblies 30 are slidably mounted to the body member 40, and used to releasably lock the battery cover 10 to the body member 40.

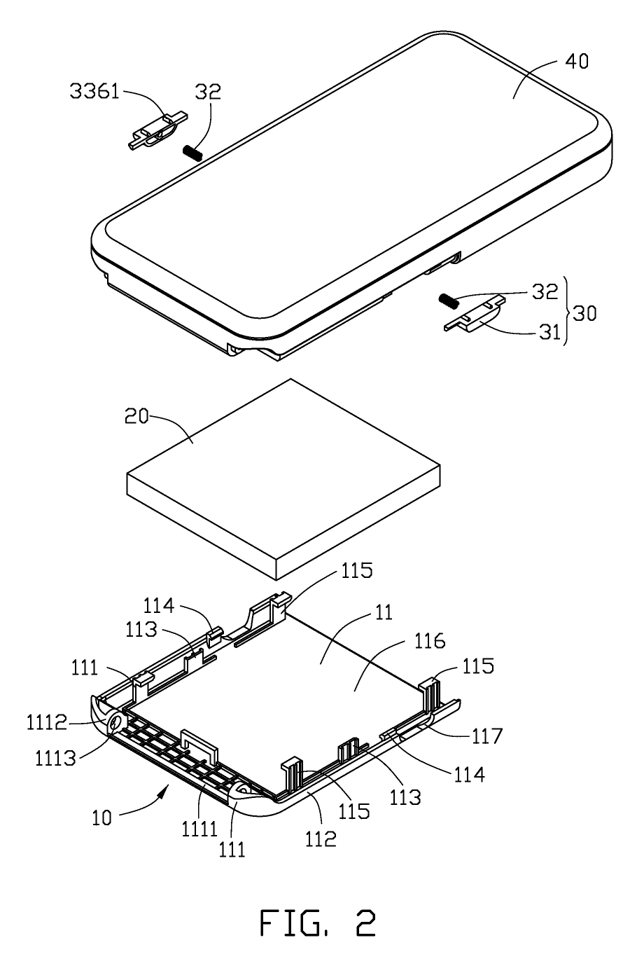

Referring to FIG. 2, the battery cover 10 includes a main board 11 with a first wall 111 and two second walls 112. The two second walls 112 are opposite to each other. The first wall 111 connects the two second walls 112 together. The first wall 111 defines a cutout 1111, forming two pivoting portions 1112. Each pivoting portion 1112 defines a pivoting hole 1113 facing the other pivoting portion 1112. The battery cover 10 further includes a plurality of limiting blocks 113, latches 114 and clamps 115. One limiting blocks 113 is formed adjacent to the first wall 111. Some limiting blocks 113, the latches 114 and clamps 115 are formed adjacent to the two second walls 112. In this embodiment, one limiting block 113 is disposed adjacent to the first wall 111. Two limiting blocks 113 are oppositely adjacent to the two second walls 112. Four clamps 115 are oppositely disposed adjacent to the two second walls 112. The limiting block 113 and two clamps 115 adjacent to one same second wall 112 are spaced apart, with the limiting block 113 between the two clamps 115. The limiting blocks 113 and the clamps 115 cooperatively enclose a receiving space 116, used to receive the battery 20 therein, thus mounting the battery 20 together with the battery cover 10. One latch 114 is disposed adjacent to each second wall 112, used to latch to the body member 40. Each second wall 112 defines a through hole 117 adjacent to the latch 114 where the button assembly 30 is received.

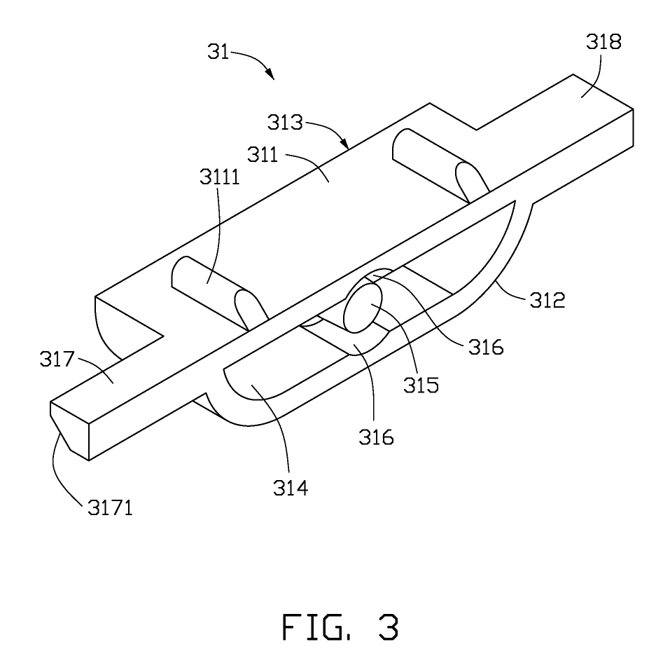

Referring to FIGS. 2 and 3 together, each button assembly 30 includes a button member 31 and an elastic member 32. The button member 31 is generally a hollow cylinder, and includes a planar wall 311, an arcuate wall 312, and an operating wall 313. The planar wall 311 and the arcuate wall 312 are connected to each other, the operating wall 313 connects the planar wall 311 and the arcuate wall 312 together, thus defining a cavity 314. A pole 315 protrudes from an interior surface of the operating wall 313. The elastic member 32 is a coiled spring, coiled around the pole 315, with one end resisting the operating wall 313. In this exemplary embodiment, the planar wall 311 and the arcuate wall 312 respectively define an arcuate slot 316, surrounding the pole 315. The two arcuate slots 316 align with each other and is used to receive the elastic member 32 therein. The planar wall 311 further includes two sliding ribs 3111 protruding from an exterior surface thereof. The two sliding ribs 3111 are parallel with each other. The button member 31 further includes a stopping block 317 and a mounting block 318. The stopping block 317 and the mounting block 318 oppositely extend from the planar wall 311. The stopping block 317 is used to latch with the latch 114, thus latching the battery cover 10 to the body member 40. The stopping block 317 includes a guiding surface 3171 facing the latch 14, used to guide the latch 14 to latch with the stopping block 317. The mounting block 318 is slidably mounted to the body member 40, thus mounting the button member 31 to the body member 40.

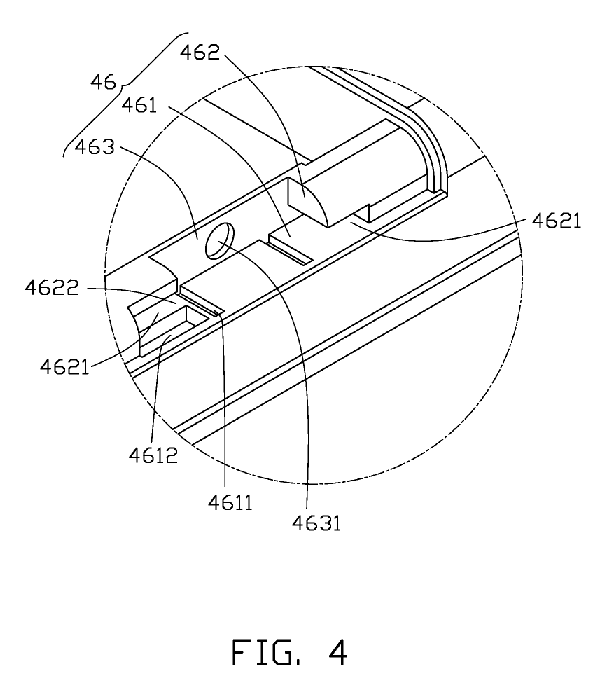

Referring to FIGS. 1 and 4 together, the body member 40 can be a housing of a portable electronic device. The body member 40 includes a top wall 41 at one end, a bottom wall 42 at another end, and two opposite sidewalls 43 between the top wall 41 and the bottom wall 42. The two sidewalls 43 connect the top wall 41 and the bottom wall 42 to enclose a battery receiving space 44. The bottom wall 42 defines two slits 421 adjacent to the two sidewalls 43. The bottom wall 42 includes two pivoting shafts 422 respectively protruding thereform and into one corresponding slit 421. The two pivoting shafts 422 are rotatably received in the pivoting holes 1113. The slits 421 are used to receive the two pivoting portions 1112 therein. The bottom wall 42 and the two sidewalls 43 define a plurality of receiving slots 45, corresponding to the liming blocks 113 and the clamps 115. The body member 40 further defines a mounting portion 46 at each sidewall 43. The mounting portion 46 is used to mount the button assemblies 30. In this embodiment, each of the mounting portion 46 is a cutout surrounded by a bottom wall 461, two sidewalls 462, and a resisting wall 463. The resisting wall 463 defines a blind hole 4631, used to receive one end of the elastic member 32. The bottom wall 461 defines two sliding slots 4611. The two sliding slots 4611 are configured for slidably receiving the sliding ribs 3111. Each sidewall 462 defines a mounting space 4621, used to slidably mount the mounting block 318 or the stopping block 317 therein. The bottom wall 461 further defines a latching hole 4612 adjacent to one sidewall 462. Each sidewall 462 is partially cut through, forming an opening 4622 to the latching hole 4612.

Referring to FIG. 3, to mount the button assembly 30 to the body member 10, the elastic member 32 is coiled around the pole 315, with one end resisting the operating wall 313. Then the button member 31 is inserted into the mounting portion 46, with the sliding ribs 3111 slidably received in the sliding slots 4611, and the other end of the elastic member received in the blind hole 4631. The stopping block 317 and the mounting block 318 are respectively received in a mounting space 4621. Thus, the button member 31 can slide in the mounting portion 46, and the stopping block 317 can partially cover the latching hole 4612.

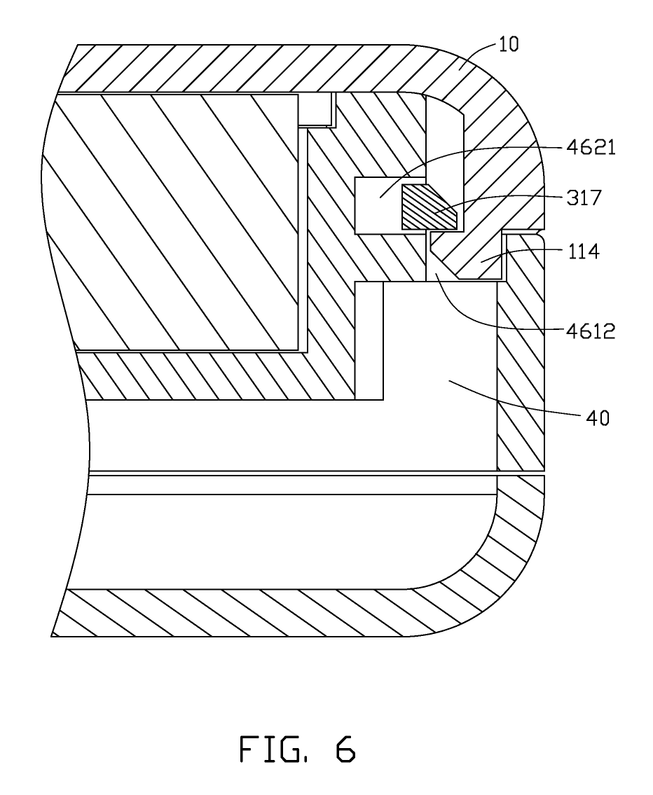

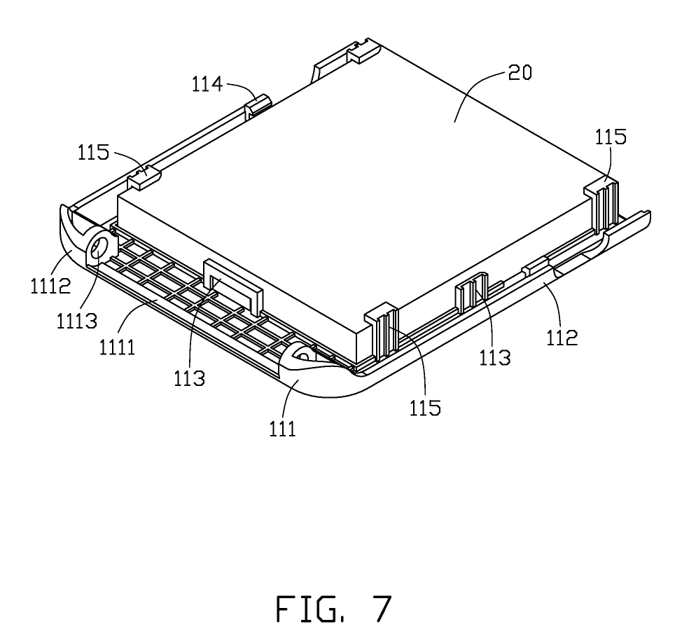

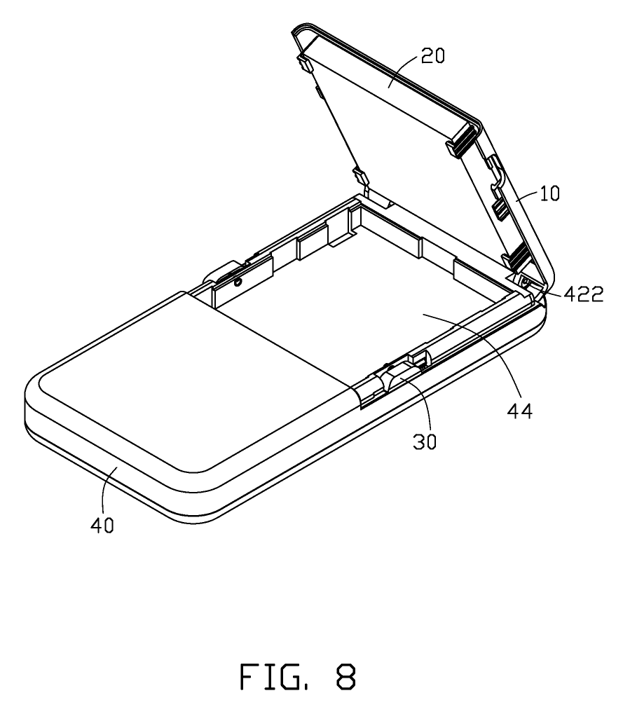

Referring to FIGS. 6 through 8, to mount the battery 20 to the body member 40, the pivoting holes 1113 of the battery cover 10 respectively receive a pivoting shaft 422 therein, with the receiving space 116 facing the body member 40. Then the battery 20 is inserted into the receiving space 116. The battery cover 10 is rotated about the pivoting shafts 422 towards the body member 40 until the latches 114 resist the guiding surfaces 3171. The battery cover 10 is further rotated about the pivoting shafts 422 towards the body member 40. The latches 114 resist the stopping blocks 317 to slide towards the battery receiving space 44 and the latches 114 are received in the latching hole 4612 over the guiding blocks 317. At this time, the stopping blocks 317 resume to latch with the latches 114, thus the battery cover 10 is tightly locked to the body member 40. The steps mentioned above are reversed, the battery 20 is taken out of the body member 40.

The battery cover latching mechanism 100 can tightly lock the battery cover 10 to the body member 40 using the button assembly 30, and also conveniently opening operation of the battery cover 20 without causing any damages to the components of the battery cover latching mechanism 100.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery cover latching mechanism, comprising:
a body member;
a battery cover including a receiving space used to mount a battery therein, one end of the battery cover being rotatably mounted to the body member; and
a button assembly used to lock another end of the battery cover to the body member.

2. The battery cover latching mechanism as claimed in claim 1, wherein the body member includes two pivoting shafts, the battery cover further including two pivoting holes, and the pivoting shafts are respectively received in the pivoting holes.

3. The battery cover latching mechanism as claimed in claim 1, wherein the receiving space is formed by a plurality of limiting blocks and clamps, the limiting blocks and the clamps protrude from the battery cover.

4. The battery cover latching mechanism as claimed in claim 3, wherein the body member defines a plurality of receiving slots for receiving the limiting blocks and the clamps.

5. The battery cover latching mechanism as claimed in claim 1, wherein a latch is formed at another end of the battery cover, the button assembly includes an elastic member and a button member, one stopping block is formed on the button member, the stopping block releasably latching with the latch of the battery cover, the elastic member used to resist the button member.

6. The battery cover latching mechanism as claimed in claim 5, wherein the body member includes a mounting portion, the mounting portion is a cutout surrounded by a bottom wall, two sidewalls, and a resisting wall, the resisting wall defines a blind hole, used to receive one end of the elastic member, the other end of the elastic member resists the button member.

7. The battery cover latching mechanism as claimed in claim 6, wherein the bottom wall defines two sliding slots, the button member includes two sliding ribs, and the two sliding slots are configured for slidably receiving the sliding ribs.

8. The battery cover latching mechanism as claimed in claim 6, wherein one sidewall defines a mounting space used to slidably mount the stopping block therein.

9. The battery cover latching mechanism as claimed in claim 7, wherein the bottom wall further defines a latching hole, used to receive the latch therein.

10. The battery cover latching mechanism as claimed in claim 9, wherein one sidewall is partially cut through, forming an opening communicating with the latching hole.

11. A battery cover latching mechanism, comprising:
a body member;
a battery cover including a receiving space used to mount a battery therein, one end of the battery cover being rotatably mounted to the body member, a latch formed at another end of the battery cover; and
a button member slidably mounted to the body member, the button member including a stopping block, the stopping block releasably latching with latch of the battery cover.

12. The battery cover latching mechanism as claimed in claim 11, wherein the body member includes two pivoting shafts, the battery cover further including two pivoting holes, and the pivoting shafts are respectively received in the pivoting holes.

13. The battery cover latching mechanism as claimed in claim 11, wherein the receiving space is defined by a plurality of limiting blocks and clamps, the limiting blocks and the clamps protrude from the battery cover.

14. The battery cover latching mechanism as claimed in claim 13, wherein the body member defines a plurality of receiving slots for receiving the limiting blocks and the clamps.

15. The battery cover latching mechanism as claimed in claim 11, further comprising an elastic member, wherein the body member includes a mounting portion, used to mount the button assembly.

16. The battery cover latching mechanism as claimed in claim 15, wherein the mounting portion is a cutout defined by a bottom wall, two sidewalls, and a resisting wall, the resisting wall defines a blind hole, used to receive one end of the elastic member, the other end of the elastic member resist the button member.

17. The battery cover latching mechanism as claimed in claim 16, wherein the bottom wall defines two sliding slots, the button member including two sliding ribs, and the two sliding slots are configured for slidably receiving the sliding ribs.

18. The battery cover latching mechanism as claimed in claim 16, wherein one sidewall defines a mounting space, used to slidably mount the stopping block therein.

19. The battery cover latching mechanism as claimed in claim 17, wherein the bottom wall further defines a latching hole, used to receive the latch therein.

20. The battery cover latching mechanism as claimed in claim 19, wherein one sidewall is partially cut through, forming an opening communicating with the latching hole.
